(19) United States
(12) Patent Application Publication
(10) Pub. No.: US 2012/0200556 A1
(43) Pub. Date: Aug. 9, 2012

(54) ELECTROOPTIC DEVICE, METHOD FOR CONTROLLING ELECTROOPTIC DEVICE, AND ELECTRONIC APPARATUS

(75) Inventors: Kazuhisa MIZUSAKO, Matsumoto-shi (JP); Hitoshi SASAKI, Shiojiri-shi (JP)

(73) Assignee: SEIKO EPSON CORPORATION, Tokyo (JP)

(21) Appl. No.: 13/368,544

(22) Filed: Feb. 8, 2012

(30) Foreign Application Priority Data
Feb. 9, 2011 (JP) 2011-025929

(51) Int. Cl. G06F 3/038

(52) U.S. Cl. 345/212

(57) ABSTRACT

In writing performed at a start pulse DY1, the writing is performed with a positive-polarity voltage, and, in writing performed at a start pulse DY2, the writing is performed with a negative-polarity voltage. In writing performed at start pulses DYR1 and DYR2, the writing is performed with a voltage that turns pixels into black of minimum gradation. Since a period in which the positive-polarity voltage is retained is different from a period in which the negative-polarity voltage is retained, a direct-current component which is applied to a liquid crystal capacitor is cancelled, whereby the occurrence of burn-in is prevented.

### BACKGROUND

1. Technical Field

The present invention relates to a technique of preventing display image burn-in in an electrooptic device.

2. Related Art

In a liquid crystal display device, when a direct-current component acts on a liquid crystal element, a disturbance in the charge balance occurs due to, for example, the polarization of a liquid crystal, and display image burn-in occurs. For this reason, in the liquid crystal display device, the liquid crystal element is generally driven by an alternating current. However, even when the liquid crystal element is driven by an alternating current, a direct-current component is sometimes applied to the liquid crystal. Thus, as an invention related to prevention of burn-in, there is an invention disclosed in JP-A-2002-189460 (Patent Document 1). This invention prevents the occurrence of burn-in by reducing a direct-current component that acts on the liquid crystal by correcting the voltage of a common electrode that faces a pixel electrode in accordance with the characteristics of a display device.

Incidentally, in the invention disclosed in Patent Document 1, since the voltage of the common electrode is corrected in alternating-current driving, an effective voltage when a positive-polarity voltage is applied to the pixel electrode is different from an effective voltage when a negative-polarity voltage is applied to the pixel electrode, and a flicker occurs.

### SUMMARY

An advantage of some aspects of the invention is to prevent the occurrence of burn-in without correcting a voltage which is applied to a pixel in accordance with the gradation.

An aspect of the invention is directed to an electrooptic device having pixels provided at intersections of a plurality of scanning lines and a plurality of data lines, the pixels each having gradation which turns into gradation in accordance with a voltage of a data signal which is supplied to the data lines when the scanning line is selected, the electrooptic device including: a scanning line driving circuit that sequentially selects the plurality of scanning lines in a predetermined order from a previously set first time of a first field in one frame, sequentially selects the plurality of scanning lines in a predetermined order from a previously set second time of a second field in the one frame, and sequentially selects the plurality of scanning lines in a predetermined order from a third time which is later than the first time and earlier than the second time or which is later than the second time and earlier than the first time of the next one frame; and a data line driving circuit that supplies, when one scanning line is selected by the selection of the scanning line from the first time, to the data lines corresponding to the pixels located in the one scanning line, a voltage corresponding to the gradations of the pixels, the voltage with one of a positive polarity which is a high potential with respect to a predetermined potential and a negative polarity which is a low potential with respect to the predetermined potential, as the data signal, supplies, when one scanning line is selected by the selection of the scanning line from the second time, to the data lines corresponding to the pixels located in the one scanning line, a voltage corresponding to the gradations of the pixels, the voltage with the other of the positive polarity and the negative polarity, as the data signal, and supplies, when one scanning line is selected by the selection of the scanning line from the third time, a predetermined voltage to the data lines corresponding to the pixels located in the one scanning line as the data signal.

According to the aspect of the invention, since, in a pixel, a period in which a positive-polarity voltage is retained is different from a period in which a negative-polarity voltage is retained, a direct-current component which is applied to the pixel is cancelled, whereby it is possible to prevent the occurrence of burn-in which is caused by the direct-current component.

In the aspect of the invention, the third time may be later than the first time and earlier than the second time.

According to this configuration, since, in a pixel, a period in which a positive-polarity voltage is retained is different from a period in which a negative-polarity voltage is retained, a direct-current component which is applied to the pixel is cancelled, whereby it is possible to prevent the occurrence of burn-in which is caused by the direct-current component.

In the aspect of the invention, the scanning line driving circuit may sequentially select the plurality of scanning lines in a predetermined order from a fourth time which is later than the second time and earlier than the first time of the next one frame, the data line driving circuit may supply, when one scanning line is selected by the selection of the scanning line from the fourth time, a predetermined voltage to the data lines corresponding to the pixels located in the one scanning line as the data signal, and a period from the first time to the third time may be different from a period from the second time to the fourth time.

According to this configuration, since, in a pixel, a period in which a positive-polarity voltage is retained is different from a period in which a negative-polarity voltage is retained, a direct-current component which is applied to the pixel is cancelled, whereby it is possible to prevent the occurrence of burn-in which is caused by the direct-current component.

In the aspect of the invention, the first time may be later than a start time of the first field and may be within a vertical blanking period with respect to the start time of the first field.

According to this configuration, it is possible to increase a difference between a period in which a positive-polarity voltage is retained and a period in which a negative-polarity voltage is retained in a pixel.

In the aspect of the invention, the third time may be later than the second time and earlier than the first time of the next one frame.

According to this configuration, in a pixel, a period in which a positive-polarity voltage is retained is different from a period in which a negative-polarity voltage is retained, and a direct-current component which is applied to the pixel is cancelled, whereby it is possible to prevent the occurrence of burn-in which is caused by the direct-current component.

In the aspect of the invention, the second time may be later than a start time of the second field and may be within a vertical blanking period with respect to the start time of the second field.

According to this configuration, it is possible to increase a difference between a period in which a positive-polarity voltage is retained and a period in which a negative-polarity voltage is retained in a pixel.

In the aspect of the invention, the electrooptic device may be a normally black mode type, and the predetermined voltage may be a voltage that turns the gradations of the pixels into black.

According to this configuration, it is possible to prevent the application of a direct-current component to a pixel by the application of a predetermined voltage.

The invention can be implemented not only as the electrooptic device but also as a method for controlling an electrooptic device and an electronic apparatus having the electrooptic device.

### BRIEF DESCRIPTION OF THE DRAWINGS

The invention will be described with reference to the accompanying drawings, wherein like numbers reference like elements.

FIG. 1 is a block diagram showing the configuration of an electrooptic device according to an embodiment.

FIG. 2 is a diagram showing the configuration of a display panel of the electrooptic device.

FIG. 3 is a diagram showing the configuration of a pixel in the display panel.

FIG. 4 is a diagram showing the configuration of an output circuit.

FIG. 5 is a diagram showing the operation of the output circuit.

FIG. 6 is a diagram showing the operation of a scanning line driving circuit in the display panel.

FIG. 7 is a diagram showing a voltage waveform example of a data signal in the display panel.

FIG. 8 is a diagram showing a voltage waveform example of a data signal in the display panel.

FIG. 9 is a diagram showing the transition of writing into a pixel in a display region.

FIG. 10 is a diagram showing the transition of writing into a pixel in the display region.

FIG. 11 is a diagram showing the configuration of a projector using the electrooptic device according to the embodiment.

FIG. 12 is a diagram showing the transition of writing into a pixel in the display region.

FIG. 13 is a diagram showing the transition of writing into a pixel in the display region.

FIG. 14 is a diagram showing the transition of writing into a pixel in the display region.

FIG. 15 is a diagram showing the transition of writing into a pixel in the display region.

FIG. 16 is a diagram showing the transition of writing into a pixel in the display region.

FIG. 17 is a diagram showing the transition of writing into a pixel in the display region.

### DESCRIPTION OF EXEMPLARY EMBODIMENTS

### First Embodiment

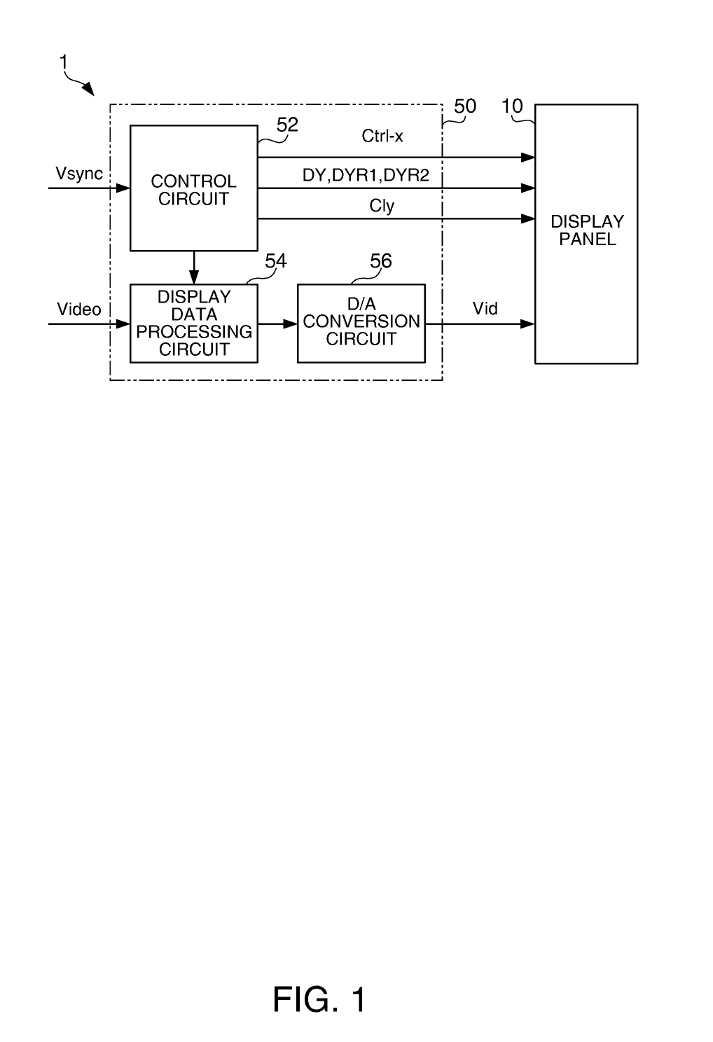

FIG. 1 is a block diagram showing the configuration of an electrooptic device 1 according to an embodiment of the invention. As shown in FIG. 1, the electrooptic device 1 is broadly divided into two parts: a display panel 10 and a processing circuit 50. Of these parts, the processing circuit 50 which is a circuit module controlling the operation etc. of the display panel 10 includes a control circuit 52, a display data processing circuit 54, and a D/A conversion circuit 56, and is connected to the display panel 10 by an FPC (flexible printed circuit) substrate, for example. Incidentally, the electrooptic device 1 is an example of a liquid crystal device that performs display of an image by using a liquid crystal.

The control circuit 52 generates various kinds of control signals for controlling the display panel 10 in synchronization with a synchronizing signal Vsync which is supplied from an external higher-level device (not shown). Incidentally, these control signals will be described appropriately later. Moreover, the control circuit 52 generates various kinds of control signals and controls the display data processing circuit 54.

The display data processing circuit 54 temporarily stores display data Video supplied from the external higher-level device in an internal memory (not shown) in accordance with control of the control circuit 52 and reads the display data Video in synchronization with the driving of the display panel 10. Incidentally, the display data Video is data specifying the gradation of a pixel in the display panel 10, and the display data Video for one frame (for all pixels of the display panel 10) is supplied with a period of 16.7 milliseconds (frequency: 60 Hz) (the waveform thereof is not shown). Moreover, the D/A conversion circuit 56 converts the read display data into an analog data signal Vid in accordance with control of the control circuit 52.

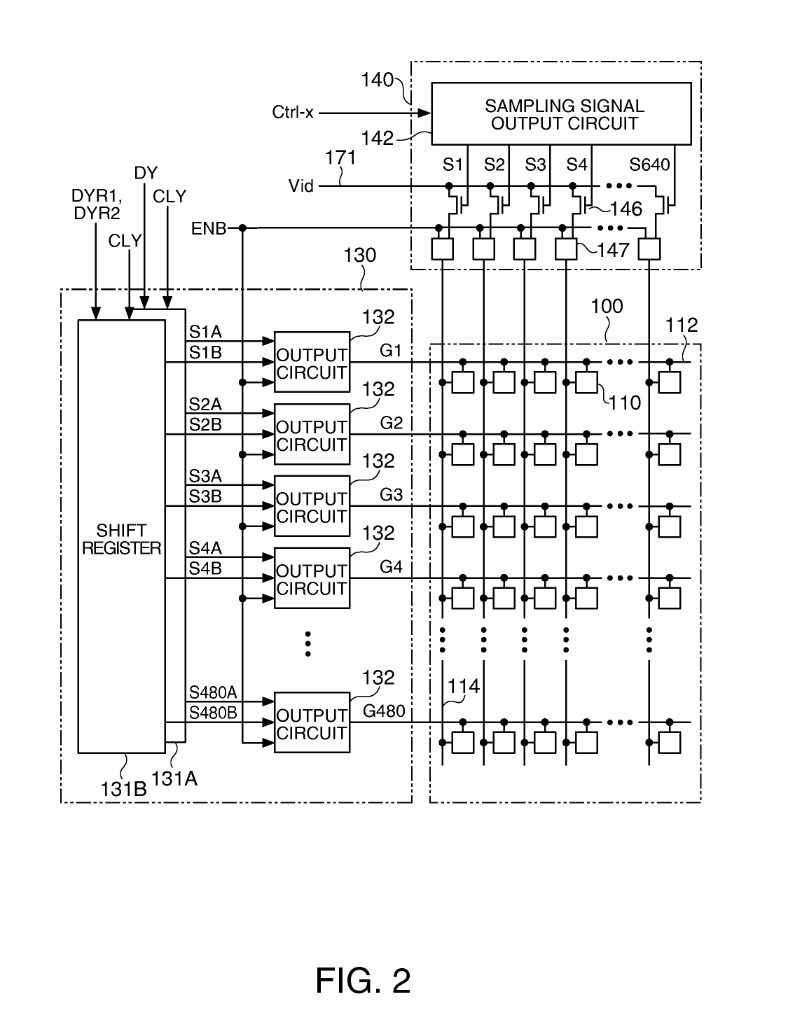

Next, the display panel 10 will be described. FIG. 2 is a diagram showing the configuration of the display panel 10. As shown in this drawing, the display panel 10 is configured as a display panel with built-in periphery circuits, that is, a display panel with a built-in scanning line driving circuit 130 and a built-in data line driving circuit 140 around a display region 100. In the display region 100, 480 scanning lines 112 are provided so as to extend in a row (X) direction, 640 data lines 114 are provided so as to extend in a column (Y) direction and maintain electrical insulation between the data lines 114 and the scanning lines 112, and pixels 110 are arranged in positions corresponding to the intersections of the 480 scanning lines 112 and 640 data lines 114. Therefore, in this embodiment, in the display region 100, the pixels 110 are arranged in a matrix with 480 rows and 640 columns; however, this does not mean to limit the invention to this particular arrangement.

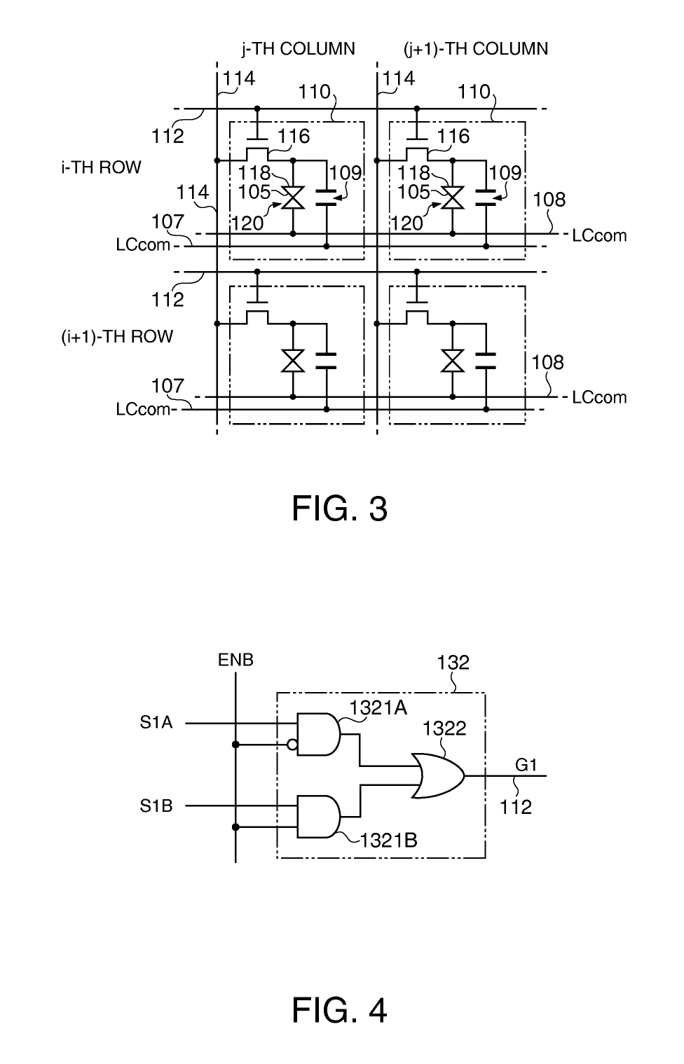

The configuration of the pixel 110 will be described with reference to FIG. 3. FIG. 3 shows the configuration of 4 (2×2) pixels corresponding to the intersections of an i-th row and an (i+1)-th row which is a next row below and a j-th column and a (j+1)-th column which is a next column located on the right side of the j-th column. Incidentally, i and (i+1) are symbols representing, in a general way, rows in which the pixels 110 are arranged and, in this description, are integers which are greater than or equal to 1 but smaller than or equal to 480. Moreover, j and (j+1) are symbols representing, in a general way, columns in which the pixels 110 are arranged and, in this description, are integers which are greater than or equal to 1 but smaller than or equal to 640.

As shown in FIG. 3, the pixels 110 each include an n-channel TFT 116 and a liquid crystal capacitor 120. Here, since the pixels 110 have the same configuration, a pixel located in an i-th row and in a j-th column will be described as a representative example. The gate electrode of the TFT 116 of the pixel 110 in the i-th row and in the j-th column is connected to the scanning line 112 in the i-th row, the source electrode thereof is connected to the data line 114 in the j-th column, and the drain electrode thereof is connected to a pixel electrode 118 which is one end of the liquid crystal capacitor 120. Moreover, the other end of the liquid crystal capacitor 120 is connected to a counter electrode 108. The counter electrode 108 is a common counter electrode of all the pixels 110, and a temporally constant voltage LCcom is applied to the counter electrode 108.

Though not shown in the drawing, the display panel 10 has a structure in which a pair of substrates: a device substrate and a counter substrate is bonded together in such a way that a predetermined space is kept between the substrates and a liquid crystal is encapsulated in this space. Of these substrates, on the device substrate, the scanning lines 112, the data lines 114, the TFTs 116, and the pixel electrodes 118 are formed along with the scanning line driving circuit 130 and the data line driving circuit 140, and the counter electrode 108 is formed on the counter substrate. The substrates are bonded together in such a way that a predetermined space is kept between them so that the faces thereof on which the electrodes are formed face each other. As a result, in this embodiment, the liquid crystal capacitor 120 is formed as a result of the pixel electrode 118 and the counter electrode 108 sandwiching a liquid crystal 105.

Incidentally, in this embodiment, the display panel 10 is configured as a normally black mode in which black display is performed when a voltage effective value retained in the liquid crystal capacitor 120 is close to zero and the transmittance of light passing through the liquid crystal capacitor becomes minimum, and white display is performed when the transmittance becomes maximum as a result of the amount of light passing through the liquid crystal capacitor increasing with an increase in the voltage effective value.

In this configuration, by turning on the TFT 116 (bringing the TFT 116 into conduction) by application of a selected voltage to the scanning line 112 and supplying a data signal with a voltage in accordance with the gradation (brightness) to the pixel electrode 118 via the data line 114 and the TFT 116 in an on state, it is possible to make the liquid crystal capacitor 120 corresponding to the intersection of the scanning line 112 to which the selected voltage is applied and the data line 114 to which the data signal is supplied retain a voltage effective value in accordance with the gradation. Therefore, it is possible to make the pixels allow different lights to pass through the liquid crystal capacitors 120, whereby an image is formed in the display region 100. Incidentally, the formed image is directly viewed by the user or is viewed by the user after being enlarged and projected as in a projector which will be described later.

Incidentally, when a non-selected voltage is applied to the scanning line 112, the TFT 116 is turned off (is brought out of conduction). Since the off resistance at this time is not ideally infinite, not a few electric charges accumulated in the liquid crystal capacitor 120 leak. To reduce the influence of this off leakage, a storage capacitor 109 is formed in each pixel. One end of the storage capacitor 109 is connected to the pixel electrode 118 (the drain of the TFT 116), and the other end thereof is connected, in all the pixels, to a common capacitor line 107. The capacitor line 107 is maintained at a temporally constant potential, for example, the voltage LCcom like the counter electrode 108.

Back in FIG. 2, the scanning line driving circuit 130 supplies scanning signals G1, G2, G3, . . . , and G480 to the scanning lines 112 in the 1st, 2nd, 3rd, . . . , and 480th rows. Here, the scanning line driving circuit 130 sets the scanning signal to the selected scanning line at H level corresponding to a voltage Vdd and sets the scanning signal to the other scanning lines at L level corresponding to a non-selected voltage (a ground voltage Gnd).

The scanning line driving circuit 130 has shift registers 131A and 131B and a plurality of output circuits 132. When a clock signal CLY rises in a state in which start pulses DY1 and DY2 supplied at the start of writing of data are at H level, the shift register 131A exclusively outputs latching signals S1A, S2A, S3A, . . . , and S480A which are pulse signals corresponding to the scanning lines in the 1st to 480th rows sequentially in accordance with the clock signal CLY.

When the clock signal CLY rises in a state in which start pulses DYR1 and DYR2 supplied at the start of writing of data are at H level, the shift register 131B exclusively outputs latching signals S1B, S2B, S3B, . . . , and S480B which are pulse signals corresponding to the scanning lines in the 1st to 480th rows sequentially in accordance with the clock signal CLY.

The output circuits 132 provided for the scanning lines 112 in the 1st to 480th rows are circuits that output the scanning signals G1 to G480.

FIG. 4 is a diagram showing the configuration of the output circuit 132. Incidentally, since the plurality of output circuits 132 have the same configuration, in FIG. 4, the output circuit 132 connected to the scanning line 112 in the 1st row is shown as a representative example. As shown in this drawing, the output circuit 132 is formed of AND circuits 1321A and 1321B and an OR circuit 1322. To one terminal of the AND circuit 1321A, the latching signal S1A is input, and, to the other terminal, a reversed output control signal ENB is input. Moreover, to one terminal of the AND circuit 1321B, the latching signal S1B is input, and, to the other terminal, an output control signal ENB is input.

When the latching signal supplied from the shift register 131A is at H level, the output circuit 132 outputs the scanning signal to the scanning line 112 when the supplied output control signal ENB is at L level. Moreover, when the latching signal supplied from the shift register 131B is at H level, the output circuit 132 outputs the scanning signal to the scanning line 112 when the supplied output control signal ENB is at H level.

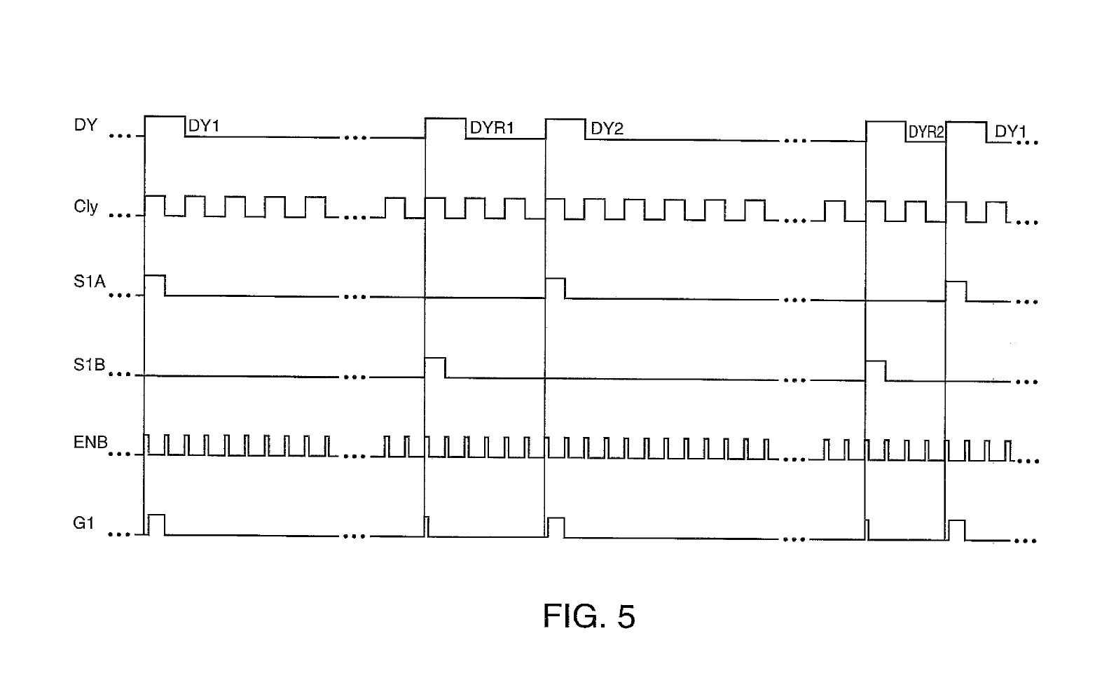

FIG. 5 is a timing chart showing a scanning signal output from the output circuit 132 in relation to the start pulses DY1, DY2, DYR1, and DYR2 and the clock signal CLY. Incidentally, in FIG. 5, the scanning signal G1 output to the scanning line 112 in the 1st row is shown as a representative example. As shown in FIG. 5, when the clock signal CLY rises in a state in which the start pulse DY1 is at H level, the latching signal S1A is output from the shift register 131A in accordance with the clock signal CLY. Here, when the latching signal S1A is input to the AND circuit 1321A, the output of the AND circuit 1321A becomes L level in a period in which the output control signal ENB is at H level. Moreover, since the latching signal S1B is at L level, the output of the AND circuit 1321B also becomes L level, and the output of the output circuit 132 becomes L level. On the other hand, when the output control signal ENB becomes L level in a period in which the latching signal S1A which is being input to the AND circuit 1321A is at H level, the output of the AND circuit 1321A becomes H level, and the scanning signal G1 is output from the output circuit 132.

Next, when the clock signal CLY rises in a state in which the start pulse DYR1 is at H level, the latching signal S1B is output from the shift register 131B in accordance with the clock signal CLY. Here, when the latching signal S1B is input to the AND circuit 1321B, the output of the AND circuit 1321B becomes H level in a period in which the output control signal ENB is at H level, and the scanning signal G1 is output from the output circuit 132. On the other hand, when the output control signal ENB becomes L level in a period in which the latching signal S1B which is being input to the AND circuit 1321B is at H level, the output of the AND circuit 1321B becomes L level, and the output of the output circuit 132 becomes L level.

Moreover, as shown in FIG. 5, when the clock signal CLY rises in a state in which the start pulse DY2 is at H level, the latching signal S1A is output from the shift register 131A in accordance with the clock signal CLY. Here, when the latching signal S1A is input to the AND circuit 1321A, the output of the AND circuit 1321A becomes L level in a period in which the output control signal ENB is at H level. Furthermore, since the latching signal S1B is at L level, the output of the AND circuit 1321B also becomes L level, and the output of the output circuit 132 becomes L level. On the other hand, when the output control signal ENB becomes L level in a period in which the latching signal S1A which is being input to the AND circuit 1321A is at H level, the output of the AND circuit 1321A becomes H level, and the scanning signal G1 is output from the output circuit 132.

Next, when the clock signal CLY rises in a state in which the start pulse DYR2 is at H level, the latching signal S1B is output from the shift register 131B in accordance with the clock signal CLY. Here, when the latching signal S1B is input to the AND circuit 1321B, the output of the AND circuit 1321B becomes H level in a period in which the output control signal ENB is at H level, and the scanning signal G1 is output from the output circuit 132. On the other hand, when the output control signal ENB becomes L level in a period in which the latching signal S1B which is being input to the AND circuit 1321B is at H level, the output of the AND circuit 1321B becomes L level, and the output of the output circuit 132 becomes L level.

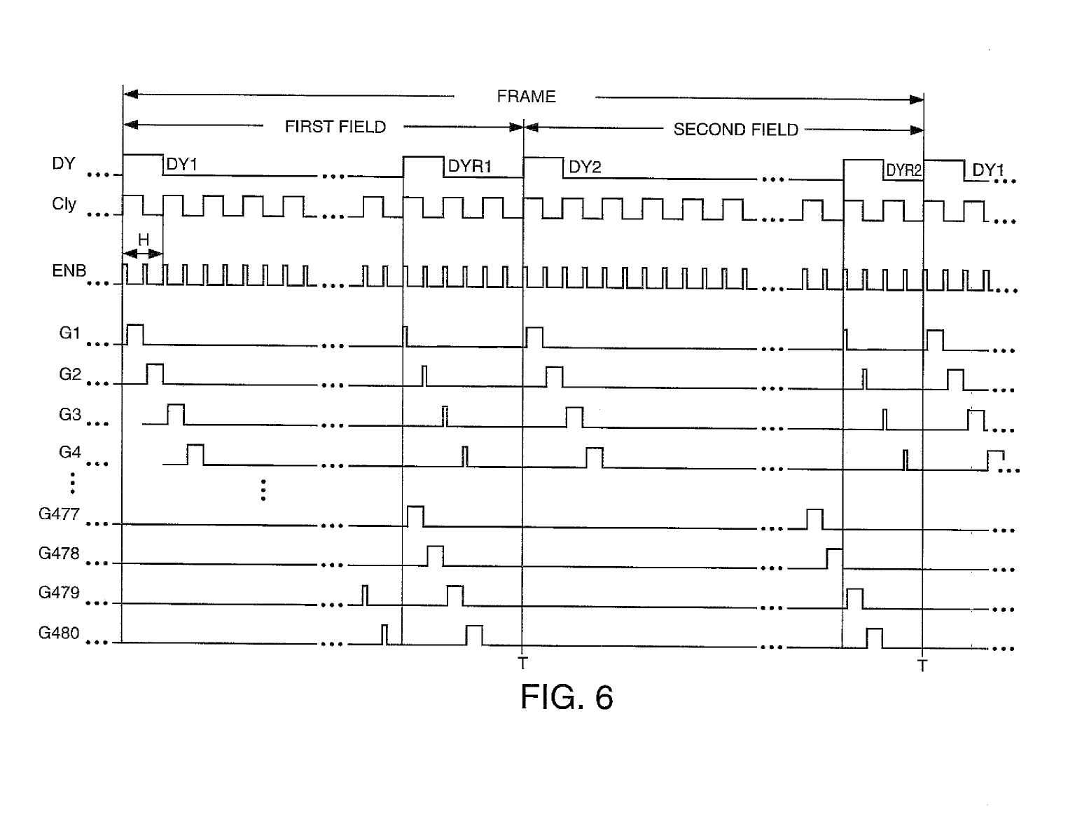

Next, FIG. 6 is a timing chart showing the scanning signals G1 to G480 output from the scanning line driving circuit 130 in relation to the start pulses DY1, DY2, DYR1, and DYR2 and the clock signal CLY. Incidentally, in this embodiment, of a period of one frame, a period from the start of the one frame to half of the one frame is referred to as a first field and a period from the half of the one frame to the end of the one frame is referred to as a second field, and a period from the output of the start pulse DY1 to the output of the start pulse DY2 and a period from the output of the start pulse DY2 to the output of the start pulse DY1 are the same in length. Moreover, the start pulses DY1 and DY2 are alternately output, and, of the start pulses DY1 and DY2, the start pulse DY1 is output at the start of one frame, that is, every 16.7 milliseconds. As a result, when the start pulse DY1 is identified, the start pulse DY2 is automatically identified. Therefore, in FIGS. 1 and 2 and other drawings, sometimes the start pulse DY1 and the start pulse DY2 are not distinguished from each other and are written as the start pulse DY.

As shown in FIG. 6, in a period of one frame, each of the scanning lines 112 is selected four times. Here, the frame refers to a period required to make the display panel 10 display one image. As described earlier, since the display data Video is supplied with a period of 16.7 milliseconds, one frame corresponds to 16.7 milliseconds of this period. The control circuit 52 outputs a clock signal CLY with 50% duty ratio over a period of one frame. Incidentally, in FIG. 6, a period of one period of the clock signal CLY is written as H.

Moreover, the control circuit 52 outputs the start pulses DY1 and DY2 having a pulse width corresponding to one period of the clock signal CLY at the rising edge of the clock signal CLY. Specifically, the control circuit 52 outputs the start pulse DY1 at the beginning (a first time) of a period of one frame, and outputs the start pulse DY2 at a time T (a second time) at which half of the period of the one frame has elapsed.

Furthermore, the control circuit 52 outputs the start pulses DYR1 and DYR2 having a pulse width corresponding to one period of the clock signal CLY at the rising edge of the clock signal CLY. Specifically, the control circuit 52 outputs the start pulse DYR1 before the start pulse DY2 is output (a third time), and outputs the start pulse DYR2 before the start pulse DY2 is output (a fourth time). Incidentally, in this embodiment, a period from when the start pulse DY1 is output to when the start pulse DYR1 is output is shorter than a period from when the start pulse DY2 is output to when the start pulse DYR2 is output. However, as will be described later, the control circuit 52 sometimes outputs the start pulse DYR1 temporally earlier or later by a unit corresponding to the period of the clock signal CLY.

The scanning line driving circuit 130 outputs the scanning signals G1 to G480 shown in FIG. 6 based on the start pulses DY1, DY2, DYR1, and DYR2 and the clock signal CLY described above. Specifically, when the scanning line driving circuit 130 is supplied with the start pulse DY1, the scanning line driving circuit 130 sequentially sets the scanning lines 112 at H level in a period in which the output control signal ENB is at L level every time the logic level of the clock signal CLY changes, and, when the scanning line driving circuit 130 is supplied with the start pulse DY2, the scanning line driving circuit 130 sequentially sets the scanning lines 112 at H level again in a period in which the output control signal ENB is at L level every time the logic level of the clock signal CLY changes. Moreover, when the scanning line driving circuit 130 is supplied with the start pulse DYR1, the scanning line driving circuit 130 sequentially sets the scanning lines 112 at H level in a period in which the output control signal ENB is at H level every time the logic level of the clock signal CLY changes, and, when the scanning line driving circuit 130 is supplied with the start pulse DYR2, the scanning line driving circuit 130 sequentially sets the scanning lines 112 at H level again in a period in which the output control signal ENB is at H level every time the logic level of the clock signal CLY changes.

As a result, each scanning line is selected four times in a certain frame in the order of the scanning lines in the 1st, 2nd, 3rd, . . . , and 480th rows by the supply of the start pulses DY1 and DYR1.

Incidentally, in this embodiment, a vertical blanking period Fb1 is provided from the selection of the scanning line in the 480th row by the scanning signal at the start pulse DY1 to the selection of the scanning line in the 1st row by the scanning signal at the next start pulse DY2. Similarly, a vertical blanking period Fb2 is provided from the selection of the scanning line in the 480th row by the scanning signal at the start pulse DY2 to the selection of the scanning line in the 1st row by the scanning signal at the start pulse DY1 in the next frame. Moreover, it is assumed that the polarity of the data signal which is supplied to the pixel electrode 118 is, for example, positive in the first field and negative in the second field. Here, when it is assumed that the vertical blanking periods Fb1 and Fb2 are each half of the blanking period of the display data Video, the first and second fields are equal to each other. Thus, a period of the first field and a period of the second field are the same in length.

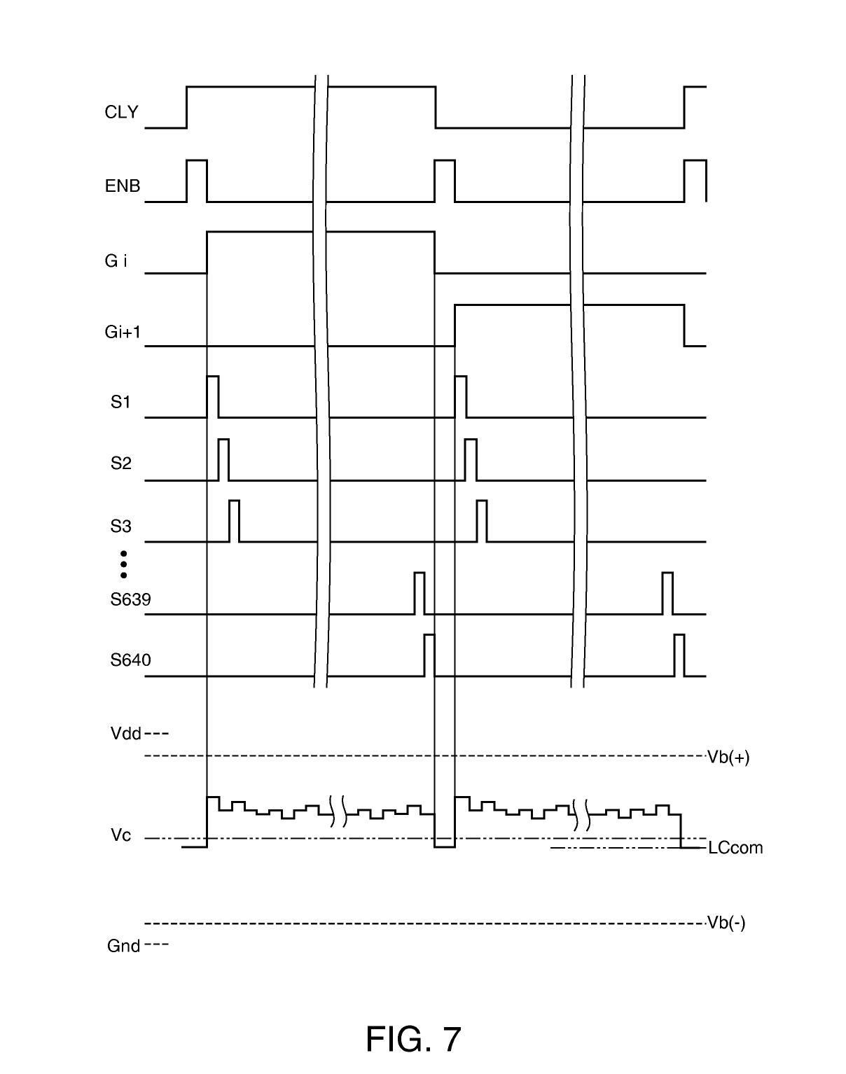

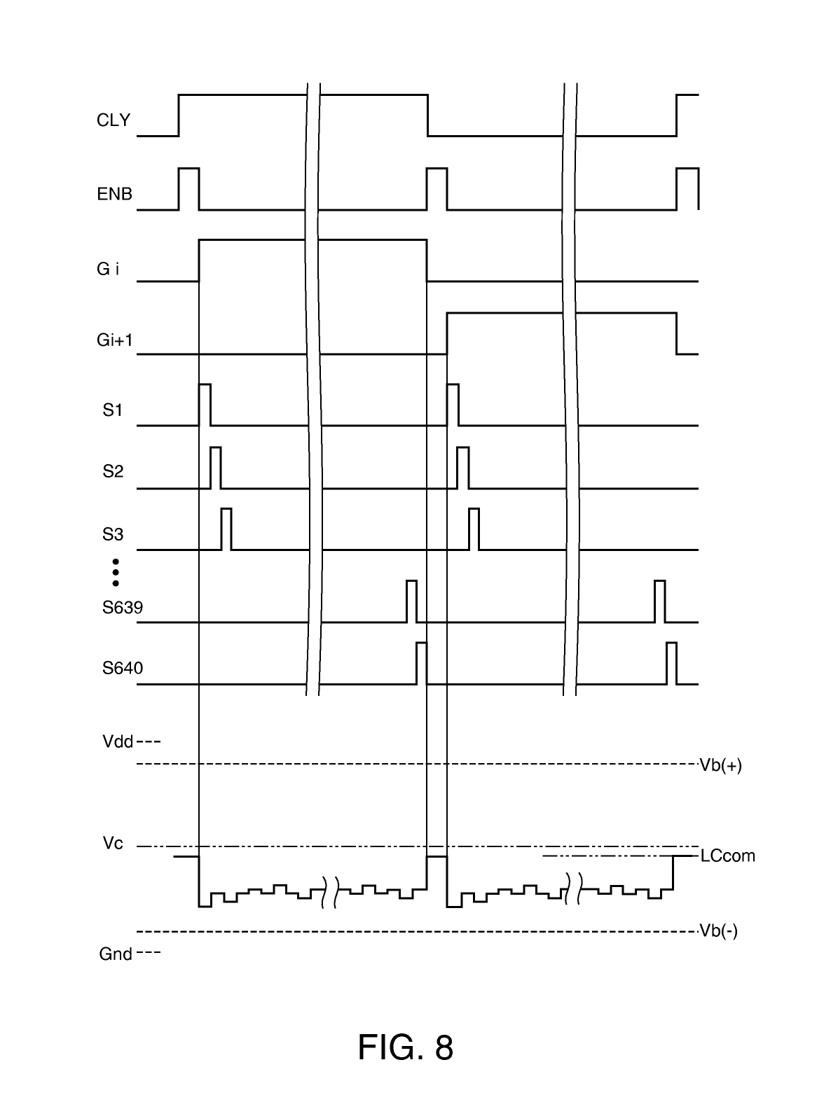

The data line driving circuit 140 is formed of a sampling signal output circuit 142, n-channel TFTs 146 provided one for each of the data lines 114, and selection circuits 147 provided one for each of the data lines 114. The sampling signal output circuit 142 outputs sampling signals S1, S2, S3, . . . , and S640 to the corresponding data lines 114, the sampling signals S1, S2, S3, . . . , and S640 which sequentially become H level exclusively in a period in which the output control signal ENB is at L level and the scanning signal is at H level as shown in FIGS. 7 and 8 in accordance with a control signal Ctrl-x from the control circuit 52. Incidentally, the control signal Ctrl-x is actually a start pulse or a clock signal, but the description thereof is omitted because it is not directly related to the invention.

Incidentally, the D/A conversion circuit 56 in FIG. 1 converts the display data Video of one row of pixels located in the scanning line 112 selected by the scanning line driving circuit 130 into a data signal Vid with the following polarity in accordance with the outputs of the sampling signals S1 to S640 by the sampling signal output circuit 142. That is, when the start pulse DY1 rises, the D/A conversion circuit 56 converts the display data Video of the pixels located in the selected row into a data signal Vid with positive polarity; when the start pulse DY2 rises, the D/A conversion circuit 56 converts the display data Video of the pixels located in the selected row into a data signal Vid with negative polarity. Incidentally, the positive polarity refers to a higher potential's-side voltage with respect to a reference voltage Vc (see FIG. 7) which is set on a higher potential side than the voltage LCcom applied to the counter electrode 108, and the negative polarity refers to a lower potential's-side voltage with respect to the reference voltage Vc. Moreover, in this embodiment, for the polarity of the data signal, the voltage Vc is used as a reference; for a voltage, unless otherwise specified, the ground voltage Gnd corresponding to an L level of a logic level is used as a reference of a voltage of 0.

When the TFT 146 is supplied with a sampling signal, the TFT 146 supplies, to the selection circuit 147, the data signal Vid which is supplied to the image signal line 171 at the time of supply of the sampling signal. The selection circuit 147 supplies, to the data line 114, a voltage that turns the pixel into black of minimum gradation or the data signal Vid supplied from the TFT 146. Specifically, in a period in which the output control signal ENB is at H level, the selection circuit 147 supplies, to the data line 114, a voltage that turns the pixel into black of minimum gradation. On the other hand, in a period in which the output control signal ENB is at L level, the selection circuit 147 supplies, to the data line 114, the data signal Vid supplied from the TFT 146.

Next, the output timing of the start pulses DYR1 and DYR2 will be described. The control circuit 52 has a first set value that adjusts the output timing of the start pulse DYR1 and a second set value that adjusts the output timing of the start pulse DYR2. The control circuit 52 makes the internal memory of the display data processing circuit 54 store the display data Video supplied from the external higher-level device and then, when selecting the scanning line in a certain row in the display panel 10, reads the display data in the row at twice the storage speed and controls, via the control signal Ctrl-x, the sampling signal output circuit 142 so that the sampling signals S1 to 5640 sequentially become H level in accordance with the reading of the display data. Incidentally, the display data thus read is converted by the D/A conversion circuit 56 into an analog data signal Vid.

Here, when the first set value and the second set value are “0”, the control circuit 52 does not output the start pulse DYR1 and the start pulse DYR2. In this case, after outputting the start pulse DY1, the control circuit 52 outputs the start pulse DY2 at time T. When the control circuit 52 outputs the start pulse DY1, the scanning lines 112 are sequentially selected in the order of the scanning lines 112 in the 1st, 2nd, 3rd, . . . , and 480th rows in the first field. It is for this reason that the control circuit 52 controls the scanning line driving circuit 130 so that the scanning line 112 in the 1st row is selected first. Moreover, the control circuit 52 makes the display data processing circuit 54 read the display data Video corresponding to the 1st row, the display data Video stored in the memory, at double speed, controls the D/A conversion circuit 56 so that the D/A conversion circuit 56 converts the display data Video into a data signal Vid with positive polarity, and controls the sampling signal output circuit 142 so that the sampling signals S1 to 5640 become H level exclusively in this order in accordance with the reading. When the sampling signals S1 to 5640 sequentially become H level, the TFTs 146 are sequentially turned on, and the data signal Vid supplied to the image signal line 171 is sampled sequentially by the data lines 114 in the 1st to 640th columns. On the other hand, when the scanning signal G1 becomes H level as a result of the scanning line 112 in the 1st row being selected, all the TFTs 116 in the pixels 110 located in the 1st row are turned on. As a result, the positive-polarity voltage of the data signal Vid sampled by the data lines 114 is directly applied to the pixel electrodes 118, and the positive-polarity voltage in accordance with the gradation specified by the display data Video is written into the liquid crystal capacitors 120 in the pixels in the 1st row and in the 1st, 2nd, 3rd, 4th, . . . , 639th, and 640th columns and is retained therein.

Next, the control circuit 52 controls the scanning line driving circuit 130 so that the scanning line 112 in the 2nd row is selected. Moreover, the control circuit 52 makes the display data processing circuit 54 read the display data Video corresponding to the 2nd line, the display data Video stored in the memory, at double speed, controls the D/A conversion circuit 56 so that the D/A conversion circuit 56 converts the display data Video into a data signal Vid with positive polarity, and controls the sampling signal output circuit 142 so that the sampling signals S1 to 5640 exclusively become H level in this order in accordance with the reading. When the scanning line 112 in the 2nd row is selected and the scanning signal G2 becomes H level, all the TFTs 116 in the pixels 110 located in the 2nd row are turned on, whereby the voltage of the data signal Vid sampled by the data lines 114 is applied to the pixel electrodes 118. As a result, the positive-polarity voltage in accordance with the gradation specified by the display data Video is written into the liquid crystal capacitors 120 in the pixels in the 2nd row and in the 1st to 640th columns and is retained therein.

Thereafter, in the first field, similar voltage writing operation is performed in the order of the 3rd, . . . , and 480th rows. As a result, the positive-polarity voltage in accordance with the gradation is written into the pixels in the 1st to 480th rows and is retained therein. Incidentally, when the start pulse DY2 is supplied at time T, in the second field, the scanning lines 112 are sequentially selected in the order of the scanning lines 112 in the 1st, 2nd, 3rd, . . . , and 480th rows, and the negative-polarity voltage in accordance with the gradation is written into the pixels in the 1st to 480th rows and is retained therein.

FIG. 7 shows an example of a voltage waveform of the data signal Vid in a period in which the scanning line in the i-th row and the scanning line in the i+1-th row are selected in the first field. In this drawing, voltages Vb(+) and Vb(−) are respectively positive-polarity and negative-polarity voltages corresponding to white and are symmetrical with respect to the reference voltage Vc. In a case where black of minimum gradation is specified when the decimal value of the gradation value specified by the display data Video is “0” and brighter gradations are specified as the decimal value increases, since this embodiment adopts a normally black mode, when the voltage of the data signal Vid is converted into a voltage with positive polarity, the voltage of the data signal Vid becomes a voltage which is closer to a lower potential side than the voltage Vb(+) as the gradation value becomes small; when the voltage of the data signal Vid is converted into a voltage with negative polarity, the voltage of the data signal Vid becomes a voltage which is closer to a higher potential side than the voltage Vb(−) as the gradation value becomes small.

In the first field, of a period in which the output control signal ENB is at L level and the scanning signal G1 is at H level, in a period in which, for example, the sampling signal S1 is at H level, the data signal Vid becomes a positive-polarity voltage in accordance with the gradation of the pixels in the i-th row and in the 1st column and then changes to positive-polarity voltages in accordance with the gradations of the pixels in the 2nd, 3rd, 4th, . . . and 640th columns in response to a change in the sampling signal. In the i+1-th row which is selected next, of a period in which the output control signal ENB is at L level and the scanning signal Gi+1 is at H level, in a period in which, for example, the sampling signal S1 is at H level, the data signal Vid becomes a positive-polarity voltage in accordance with the gradation of the pixels in the i+1-th row and in the 1st column and then changes to positive-polarity voltages in accordance with the gradations of the pixels in the 2nd, 3rd, 4th, . . . , and 640th columns in response to a change in the sampling signal. Incidentally, since, in the second field, the data signal has a polarity obtained by reversing the polarity of the data signal in the first field, when the scanning line is selected, the voltage waveform of the data signal Vid becomes a voltage waveform shown in FIG. 8. Moreover, in FIGS. 7 and 8, for convenience sake, a vertical scale showing the voltage of the data signal Vid is enlarged as compared to the vertical scales for the other signals.

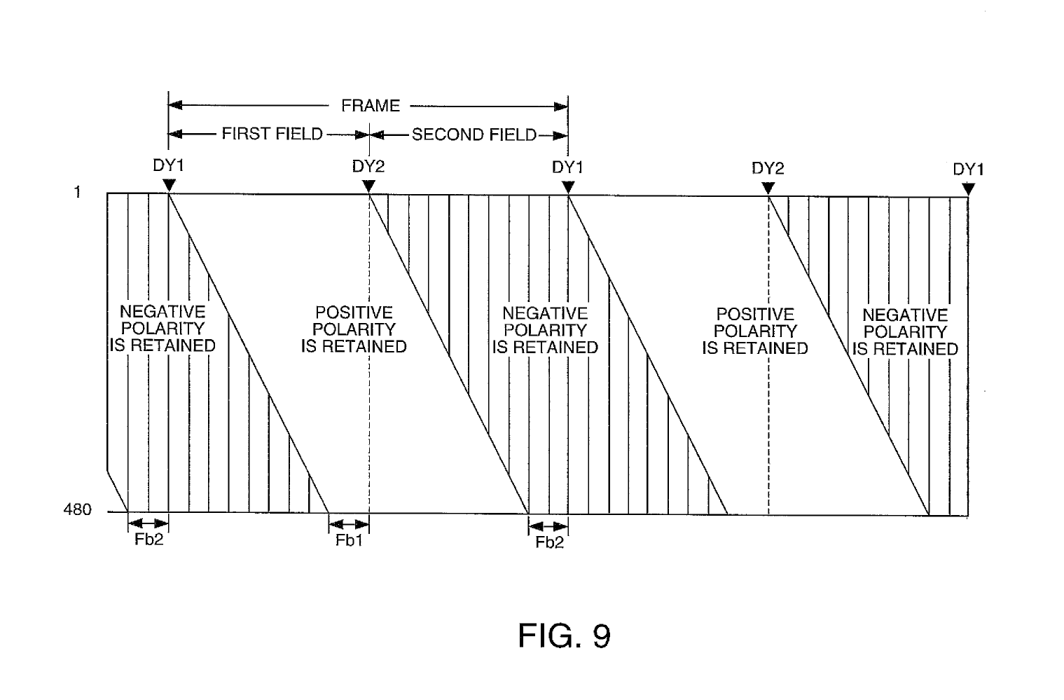

Next, FIG. 9 is a diagram showing the writing states of the rows with time in consecutive frames when the start pulses DYR1 and DYR2 are not supplied. As shown in this drawing, in this embodiment, in the first field, in the pixels in the 1st to 480th rows, writing of a positive-polarity voltage is performed, and, in the second field, in the pixels in the 1st to 480th rows, writing of a negative-polarity voltage is performed. When the first set value and the second set value are “0” and the start pulse DY2 is supplied at time T, since periods of the first and second fields are each half of a period of one frame, in each pixel, a period in which the positive-polarity voltage is retained in the liquid crystal capacitor 120 and a period in which the negative-polarity voltage is retained therein are the same in length.

Incidentally, as shown in FIG. 7, the voltage LCcom which is applied to the counter electrode 108 is set on a lower potential side than the reference voltage Vc at the factory. The reasons are as follows. In an active matrix electrooptic device in which a pixel electrode is driven by a TFT, so-called pushdown occurs and a leakage of the liquid crystal capacitor which occurs when the positive-polarity voltage is retained differs from the leakage which occurs when the negative-polarity voltage is retained. If the voltage LCcom is matched with the reference voltage Vc, the voltage effective value of the liquid crystal capacitor 120 by the writing of the negative polarity is slightly greater than the voltage effective value by the writing of the positive polarity (when the TFT 116 is an n-channel TFT). Thus, by being offset on a lower potential side than the reference voltage Vc, the voltage LCcom is set at an optimal value at which such a difference is cancelled.

In this embodiment, when the start pulse DY2 is supplied at time T and the start pulses DYR1 and DYR2 are not supplied, in each pixel, since a period in which the positive-polarity voltage is retained in the liquid crystal capacitor 120 and a period in which the negative-polarity voltage is retained in the liquid crystal capacitor 120 are each half of a period of a frame, no direct-current component is supposed to be applied to the liquid crystal capacitor 120. However, when the amount of pushdown of the TFT and the amount of leakage in the liquid crystal capacitor change from those set at the factory due to deterioration over time or the like, the voltage LCcom is not an optimal value any more, and a direct-current component is applied to the liquid crystal capacitor 120. Therefore, in this embodiment, to prevent the application of a direct-current component, the start pulses DYR1 and DYR2 are output in accordance with the values of the first set value and the second set value, whereby the application of a direct-current component to the liquid crystal capacitor 120 is controlled.

When the first set value is “n” (n is an integer), the control circuit 52 outputs the start pulse DYR1 after making an output time at which the start pulse DYR1 is output earlier than the start pulse DY2 by n period of the clock signal CLY. Moreover, when the second set value is “m” (m is an integer), the control circuit 52 outputs the start pulse DYR2 after making an output time at which the start pulse DYR2 is output earlier than the start pulse DY1 by m period of the clock signal CLY.

For example, when the display panel 10 has characteristics by which a direct-current component which is applied to the liquid crystal capacitor 120 increases on the negative polarity side, in this embodiment, the first set value and the second set value are set so that the first set value>the second set value. For example, when the first set value is set at 4 and the second set value is set at 2, a period in which the positive-polarity voltage is applied is shorter than a period in which the negative-polarity voltage is applied by two periods of the clock signal CLY.

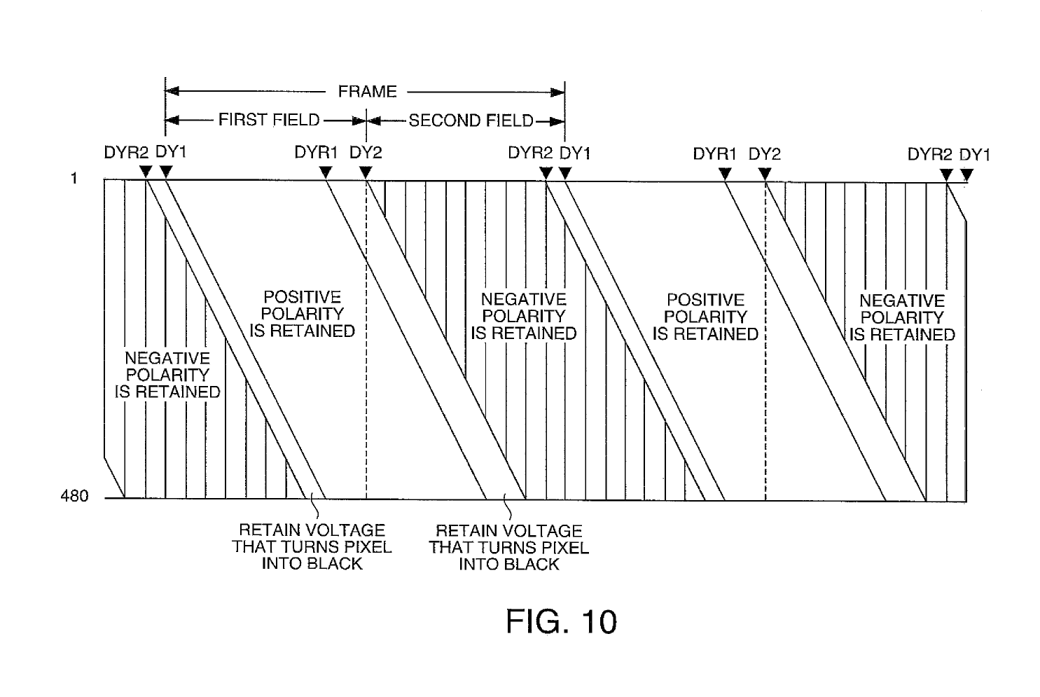

FIG. 10 is a diagram showing the writing states of the rows with time in consecutive frames when the start pulses DYR1 and DYR2 are supplied. In a period from the writing performed at the start pulse DY1 to the writing performed at the start pulse DYR1, the pixels retain the positive-polarity voltage in accordance with the gradation. When the scanning signal is output again at the start pulse DYR1, in a period in which the scanning signal is output, a voltage that turns the pixels into black of minimum gradation is supplied to the data lines 114 from the selection circuits 147. As a result, in a period from the writing performed at the start pulse DYR1 to the writing performed at the start pulse DY2, the pixels are black of minimum gradation.

Moreover, in a period from the writing performed at the start pulse DY2 to the writing performed at the start pulse DYR2, the pixels retain the negative-polarity voltage in accordance with the gradation. When the scanning signal is output again at the start pulse DYR2, in a period in which the scanning signal is output, a voltage that turns the pixels into black of minimum gradation is supplied to the data lines 114 from the selection circuits 147. As a result, in a period from the writing performed at the start pulse DYR2 to the writing performed at the next start pulse DY1, the pixels are black of minimum gradation.

Incidentally, since a period from when the start pulse DY1 is output to when the start pulse DYR1 is output is shorter than a period from when the start pulse DY2 is output to when the start pulse DYR2 is output, as shown in FIG. 10, a period in which the positive-polarity voltage written by the selection performed by the supply of the start pulse DY1 is retained is shorter than a period in which the negative-polarity voltage written by the selection performed by the supply of the start pulse DY2 is retained. Therefore, in the pixels, since the voltage effective value retained by the negative-polarity voltage increases and the voltage effective value retained by the positive-polarity voltage decreases, the direct-current component which is applied to the liquid crystal capacitor 120 changes. Then, since the voltage effective value retained by the negative-polarity voltage becomes greater than the voltage effective value retained by the positive-polarity voltage and the direct-current component which is applied to the liquid crystal capacitor 120 is cancelled, it is possible to prevent the occurrence of burn-in which is caused by the direct-current component.

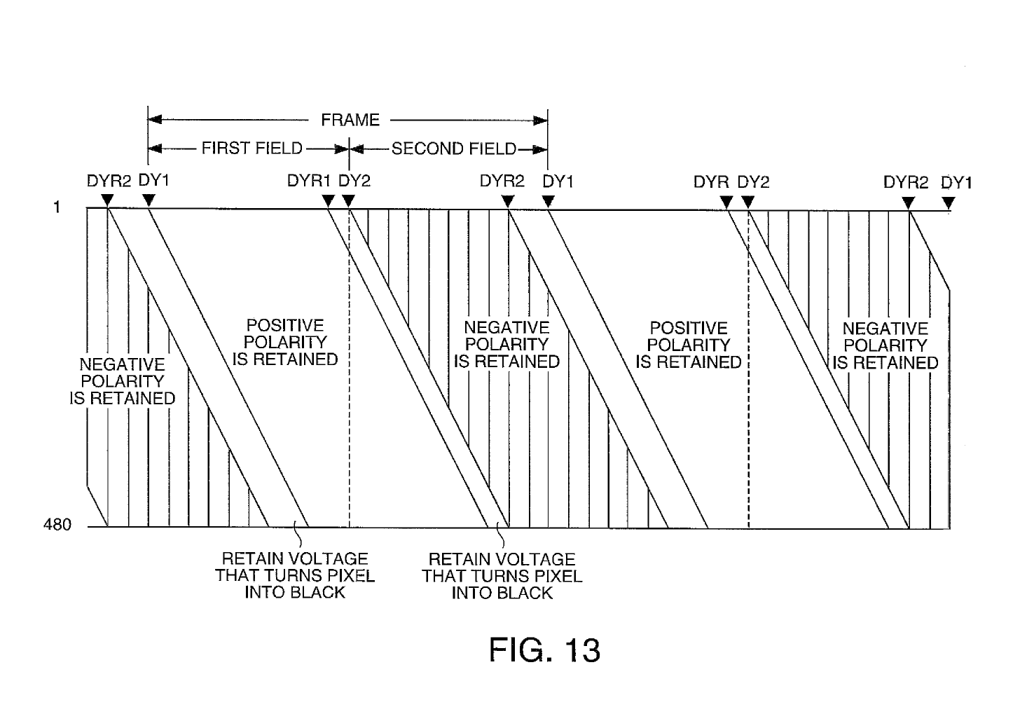

Incidentally, a configuration for preventing burn-in is not limited to the configuration described above. For example, to prevent burn-in in the display panel 10 having characteristics by which a direct-current component which is applied to the liquid crystal capacitor 120 increases on the positive polarity side, the first set value and the second set value may be set so that the first set value<the second set value, the writing into the pixels may be performed with the positive-polarity voltage in writing performed at the start pulse DY1, and the writing into the pixels may be performed with the negative-polarity voltage in writing performed at the start pulse DY2. According to this configuration, as shown in FIG. 13, a period in which the positive-polarity voltage written by the selection performed by the supply of the start pulse DY1 is retained is longer than a period in which the negative-polarity voltage written by the selection performed by the supply of the start pulse DY2 is retained. Therefore, in the pixels, since the voltage effective value retained by the positive-polarity voltage increases and the voltage effective value retained by the negative-polarity voltage decreases, the direct-current component which is applied to the liquid crystal capacitor 120 changes. Then, since the voltage effective value retained by the positive-polarity voltage becomes greater than the voltage effective value retained by the negative-polarity voltage and the direct-current component which is applied to the liquid crystal capacitor 120 is cancelled, it is possible to prevent the occurrence of burn-in which is caused by the direct-current component.

### Electronic Apparatus

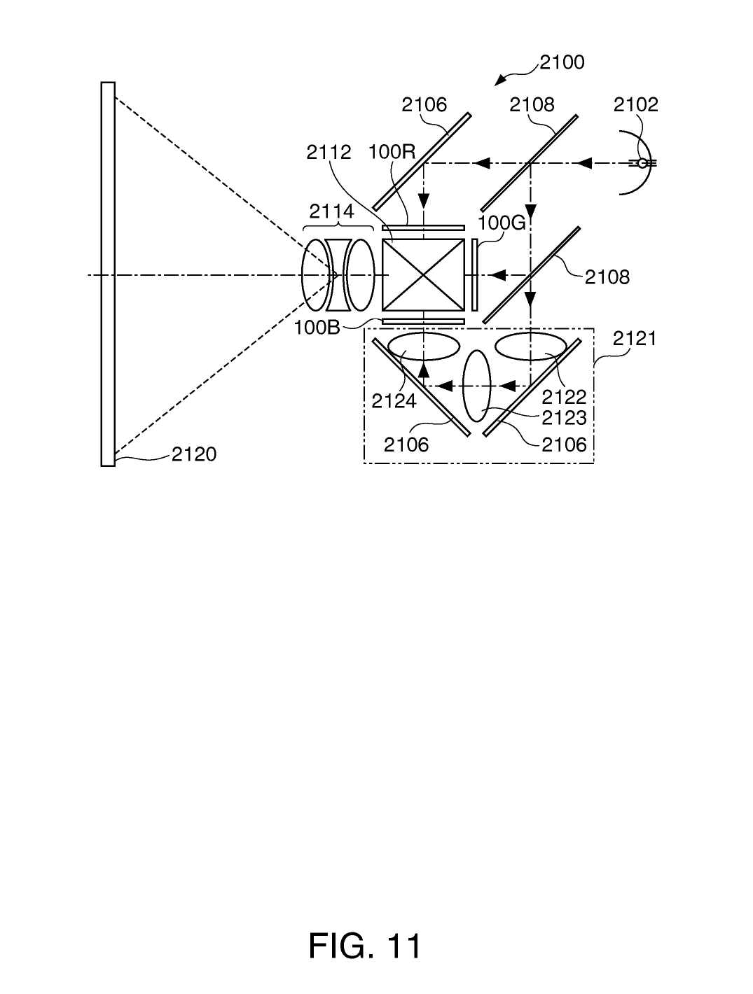

Next, an example of an electronic apparatus using the electrooptic device according to the embodiment described above will be described. FIG. 11 is a plan view showing the configuration of a three-panel projector using the display panel 10 of the electrooptic device 1 described above as a light valve.

In a projector 2100, a light which is made to enter a light valve is separated into three primary colors: R (red), G (green), and B (blue) by three mirrors 2106 and two dichroic mirrors 2108 which are disposed inside the projector 2100 and are guided to light valves 100R, 100G, and 100B, respectively, which correspond to the primary colors. Incidentally, the B light has a longer optical path than the other lights: the R light and the G light. Therefore, to prevent the loss of the B light, the B light is guided via a relay lens system 2121 formed of an entrance lens 2122, a relay lens 2123, and an exit lens 2124.

Here, the light valves 100R, 100G, and 100B have the same configuration as that of the display panel 10 in the embodiment described above and are respectively driven by the image data corresponding to the colors: R, G, and B which are supplied from an external higher-level device (not shown). The lights modulated by the light valves 100R, 100G, and 100B enter a dichroic prism 2112 from three directions. Then, in the dichroic prism 2112, the R light and the B light are refracted 90 degrees and the G light travels in a straight line. Therefore, after images of these colors are combined, since the resultant image is enlarged in a forward direction and projected by a lens unit 2114, a color image is projected onto a screen 2120.

Incidentally, while the images passing through the light valves 100R and 100B are reflected by the dichroic prism 2112 and are then projected, the image passing through the light valve 100G is projected as it is. Thus, the images formed by the light valves 100R and 100B and the image formed by the light valve 100G are mirror-reversed images.

Incidentally, some examples of the electronic apparatus include, in addition to that described above by referring to FIG. 11, a rear projection television, a direct-view-type display, monitors of, for example, a mobile phone, a personal computer, and a video camera, a car navigation device, a pager, an electronic organizer, an electronic calculator, a word processor, a work station, a videophone, a POS terminal, a digital still camera, and an apparatus with a touch panel. It goes without saying that the electrooptic device according to the invention can be applied to these various types of electronic apparatuses.

### Second Embodiment

Next, a second embodiment of the invention will be described. An electronic apparatus according to the second embodiment of the invention is the same as the first embodiment in hardware configuration, but differs therefrom in a period in which the positive-polarity voltage is retained and a period in which the negative-polarity voltage is retained. The description of the hardware configuration which is the same as that of the first embodiment is omitted, and only a difference from the first embodiment will be described.

In the first embodiment described earlier, a period in which the positive-polarity voltage is retained is made shorter than a period in which the negative-polarity voltage is retained by outputting the start pulses DYR1 and DYR2; however, a method for making a period in which the positive-polarity voltage is retained shorter than a period in which the negative-polarity voltage is retained is not limited to the configuration of the first embodiment described earlier. In this embodiment, the first set value is “n” and the second set value is “0”.

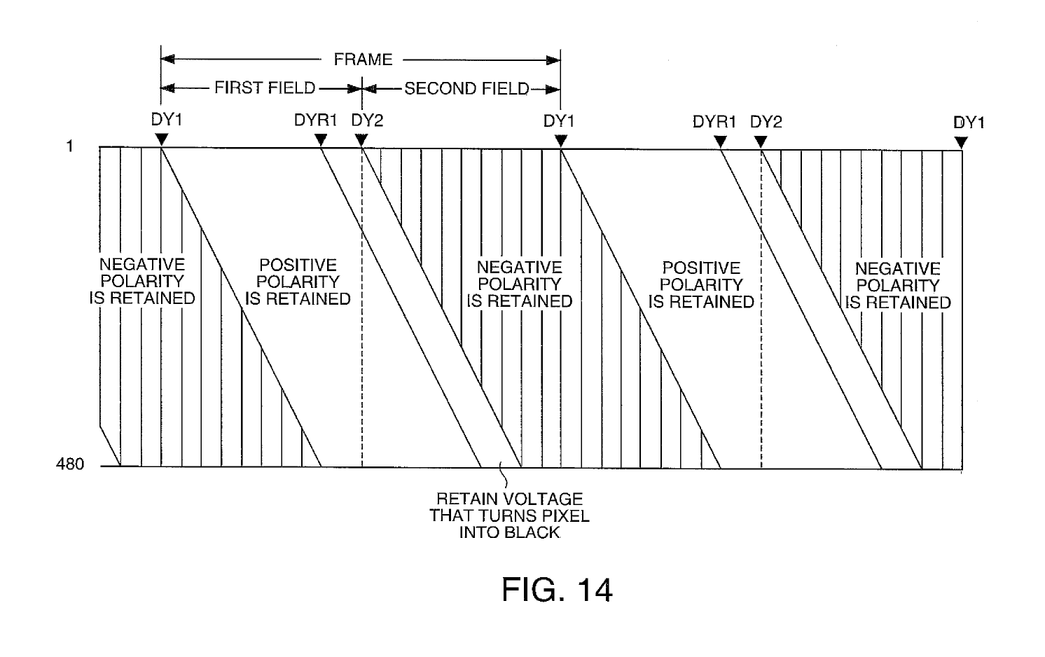

According to this configuration, as shown in FIG. 14, in one frame, the start pulse DY1 is output at a first time, the start pulse DYR1 is output at a third time in accordance with the first set value, and the start pulse DY2 is output at a second time. When the scanning signal is output again at the start pulse DYR1, in a period in which the scanning signal is output, a voltage that turns the pixels into black of minimum gradation is supplied to the data lines 114 from the selection circuits 147. As a result, in a period from the writing performed at the start pulse DYR1 to the writing performed at the start pulse DY2, the pixels are black of minimum gradation. On the other hand, since the start pulse DYR2 is not output when the second set value is “0”, the time during which the negative-polarity voltage is applied is the time from the start pulse DY2 to the start pulse DY1 as shown in FIG. 14. Thus, as in the embodiment described earlier, a period in which the positive-polarity voltage written by the selection performed by the supply of the start pulse DY1 is retained is shorter than a period in which the negative-polarity voltage written by the selection performed by the supply of the start pulse DY2 is retained.

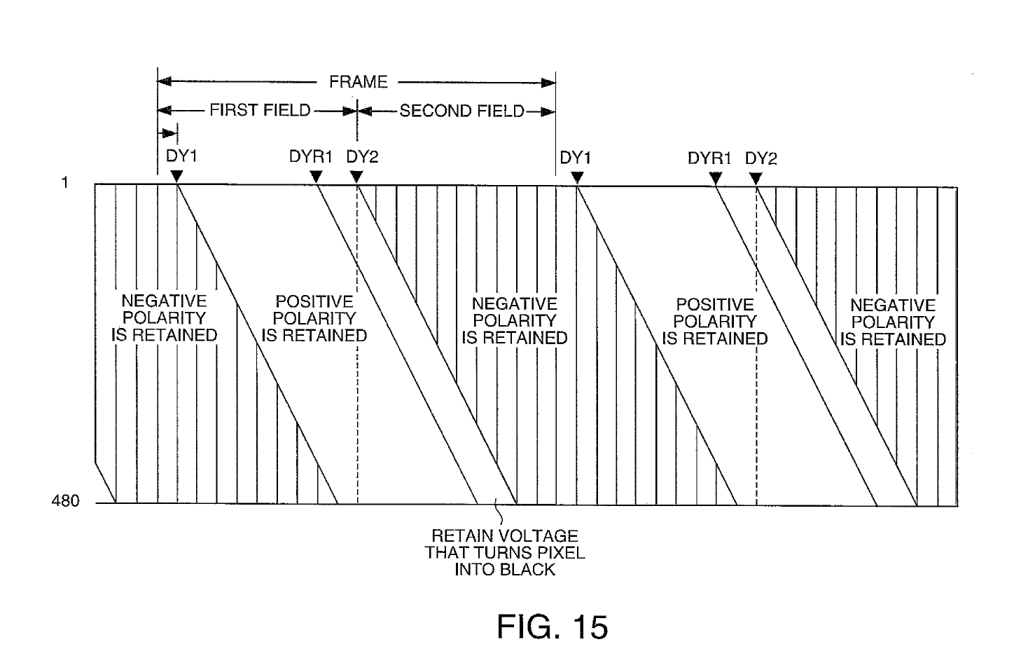

Incidentally, when the first set value is “n” and the second set value is “0”, as shown in FIG. 15, the time at which the start pulse DY1 is output (the first time) may be delayed within the range of the vertical blanking period. According to this configuration, a period in which the positive-polarity voltage written by the selection performed by the supply of the start pulse DY1 is retained is further shorter than a period in which the negative-polarity voltage written by the selection by the supply of the start pulse DY2 is retained.

### Third Embodiment

Next, a third embodiment of the invention will be described. An electronic apparatus according to the third embodiment of the invention is the same as the first embodiment in hardware configuration, but differs therefrom in a period in which the positive-polarity voltage is retained and a period in which the negative-polarity voltage is retained. The hardware configuration which is the same as that of the first embodiment is omitted, and only a difference from the first embodiment will be described.

In this embodiment, in writing performed at the start pulse DY1, the writing into the pixels is performed with the positive-polarity voltage; in writing performed at the start pulse DY2, the writing into the pixels is performed with the negative-polarity voltage. Moreover, in this embodiment, the first set value is “0” and the second set value is “m”.

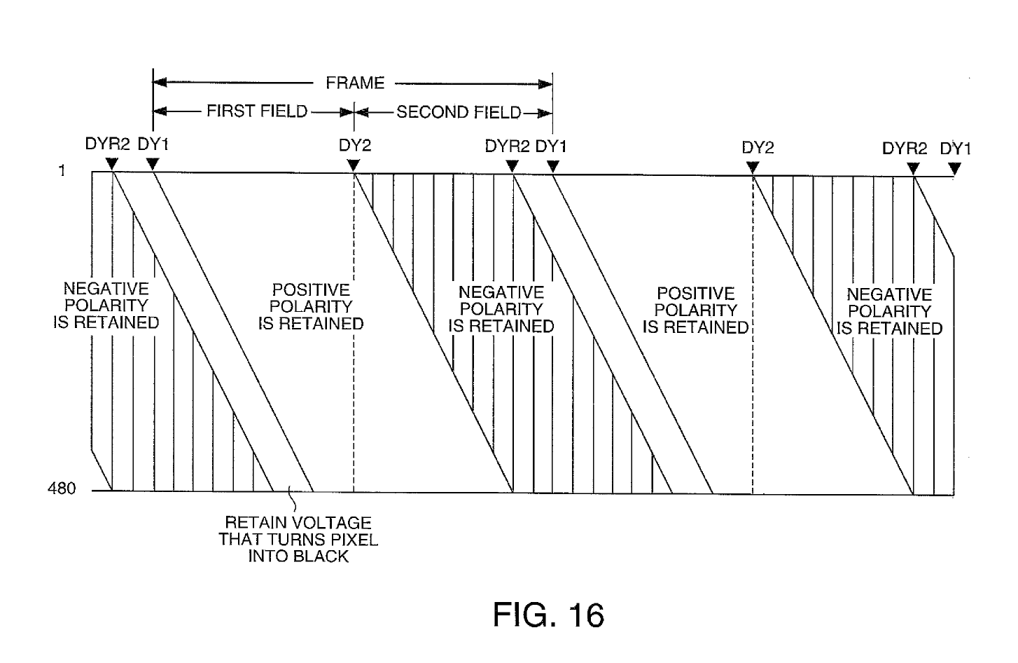

According to this configuration, as shown in FIG. 16, in one frame, the start pulse DY1 is output at a first time, the start pulse DY2 is output at a second time, and the start pulse DYR2 is output at a third time in accordance with the second set value. Since the start pulse DYR1 is not output when the first set value is “0”, as shown in FIG. 16, the time during which the positive-polarity voltage is retained is the time from the start pulse DY1 to the start pulse DY2. On the other hand, when the second set value is a value other than 0, the start pulse DYR2 is output in accordance with the second set value. When the scanning signal is output again at the start pulse DYR2, in a period in which the scanning signal is output, a voltage that turns the pixels into black of minimum gradation is supplied to the data lines 114 from the selection circuits 147. As a result, in a period from the writing performed at the start pulse DYR2 to the writing performed at the start pulse DY1, the pixels are black of minimum gradation. According to this configuration, as shown in FIG. 16, a period in which the positive-polarity voltage written by the selection performed by the supply of the start pulse DY1 is retained is longer than a period in which the negative-polarity voltage written by the selection performed by the supply of the start pulse DY2 is retained.

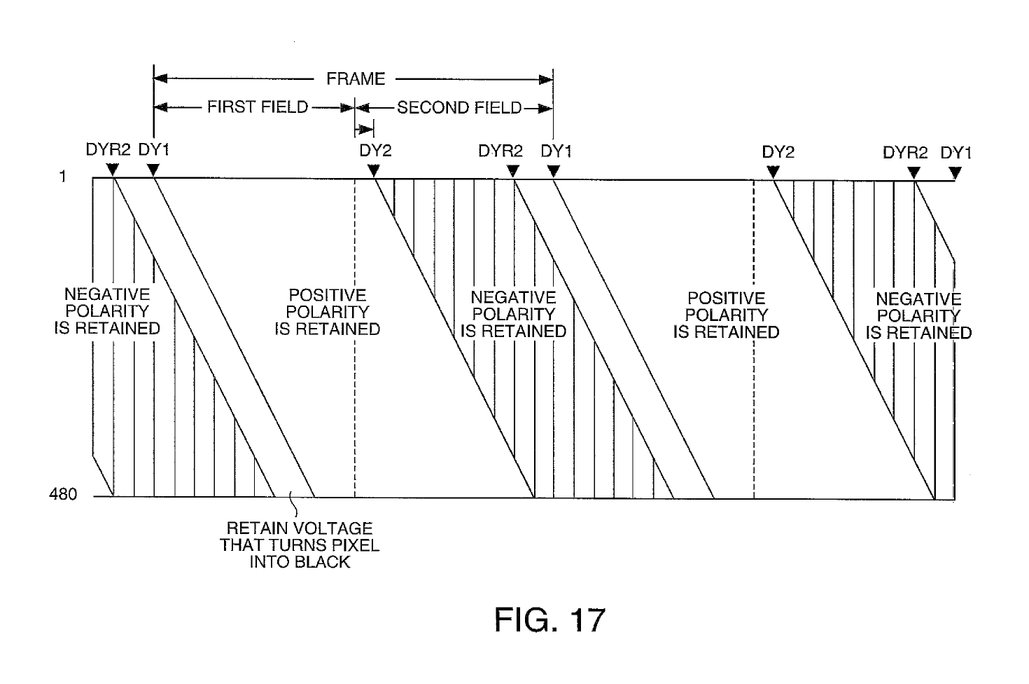

Incidentally, when the first set value is “0” and the second set value is “m”, as shown in FIG. 17, the time at which the start pulse DY2 is output (the second time) may be delayed within the range of the vertical blanking period. According to this configuration, a period in which the negative-polarity voltage written by the selection performed by the supply of the start pulse DY2 is retained is further shorter than a period in which the positive-polarity voltage written by the selection performed by the supply of the start pulse DY1 is retained.

### Modified Examples

While the embodiments of the invention have been described heretofore, the invention is not limited to the embodiments described above and can be implemented in various other forms. For example, the invention may be implemented by modifying the embodiments described above as follows. Incidentally, the embodiments described above and the following modified examples may be combined.

In the embodiments described above, the description has been given by taking the characteristics by which a direct-current component which is applied to the liquid crystal capacitor 120 increases on the negative polarity side as an example of the characteristics of the display panel 10. However, there is a display panel 10 with characteristics by which a direct-current component which is applied to the liquid crystal capacitor 120 increases on the positive polarity side. In the display panel 10 with such characteristics, as described earlier, it is necessary simply to set the first set value and the second set value so that the first set value>the second set value, in writing performed at the start pulse DY1, perform the writing into the pixels with the negative-polarity voltage, and, in writing performed at the start pulse DY2, perform the writing into the pixels with the positive-polarity voltage.

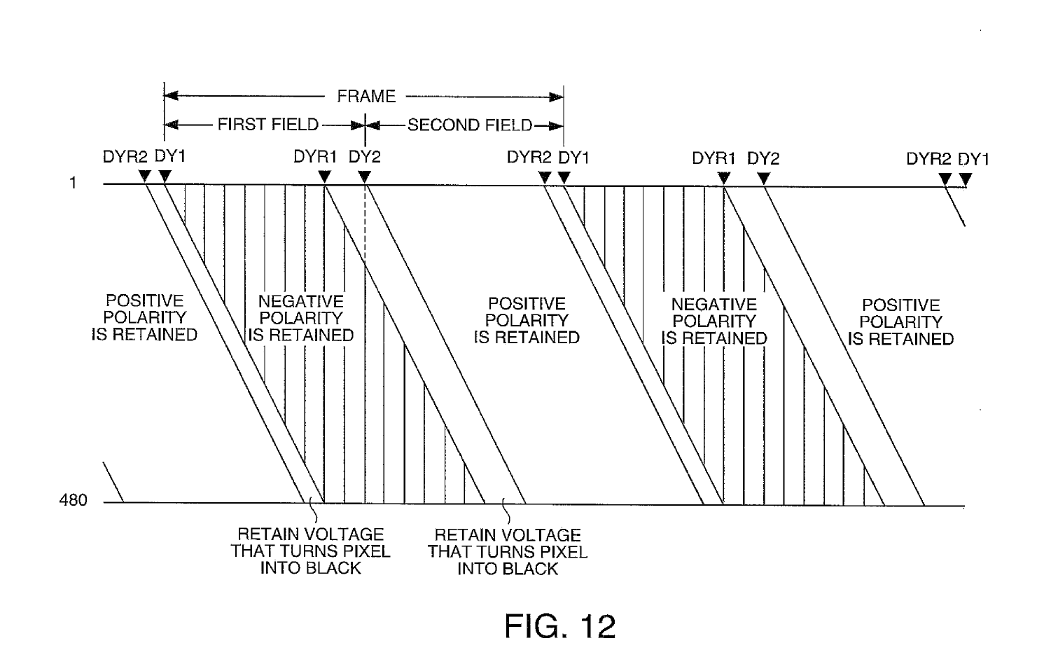

According to this configuration, as shown in FIG. 12, a period in which the negative-polarity voltage written by the selection performed by the supply of the start pulse DY1 is retained is shorter than a period in which the positive-polarity voltage written by the selection performed by the supply of the start pulse DY2 is retained. Therefore, in the pixels, since the voltage effective value retained by the positive-polarity voltage increases and the voltage effective value retained by the negative-polarity voltage decreases, the direct-current component which is applied to the liquid crystal capacitor 120 changes. Then, since the voltage effective value retained by the positive-polarity voltage becomes greater than the voltage effective value retained by the negative-polarity voltage and the direct-current component which is applied to the liquid crystal capacitor 120 is cancelled, it is possible to prevent the occurrence of burn-in which is caused by the direct-current component.

In the embodiments described above and the modified example, in writing performed by the supply of the start pulses DYR1 and DYR2, a voltage that turns the pixels into black of minimum gradation is supplied to the pixels. However, in writing performed by the supply of the start pulses DYR1 and DYR2, as long as a voltage is a voltage that turns the pixels into constant gradation, a voltage that turns the pixels into other gradations, not a voltage that turns the pixels into black of minimum gradation, may be supplied to the data lines 114.

In the embodiments described above and the modified examples, the liquid crystal capacitor 120 is configured as a normally black mode; however, the liquid crystal capacitor 120 is not limited to a normally black mode configuration and may be a normally white mode configuration.

In the embodiments described above and the modified examples, the first set value and the second set value may be made changeable by supplying the first set value and the second set value to the control circuit 52 from the external higher-level device. Moreover, in such a configuration in which the first set value and the second set value can be changed, the first set value and the second set value may be set in accordance with operations performed on an operating section for operating the electronic apparatus, the operation section such as keys and buttons which are provided in the electronic apparatus having the electrooptic device 1.

The entire disclosure of Japanese Patent Application No. 2011-025929, filed Feb. 9, 2011 is expressly incorporated by reference herein.

What is claimed is:

1. An electrooptic device having pixels provided at intersections of a plurality of scanning lines and a plurality of data lines, the pixels each having gradation which turns into gradation in accordance with a voltage of a data signal which is supplied to the data lines when the scanning line is selected, the electrooptic device comprising:
a scanning line driving circuit that sequentially selects the plurality of scanning lines in a predetermined order from a previously set first time of a first field in one frame, sequentially selects the plurality of scanning lines in a predetermined order from a previously set second time of a second field in the one frame, and sequentially selects the plurality of scanning lines in a predetermined order from a third time which is later than the first time and earlier than the second time or which is later than the second time and earlier than the first time of the next one frame; and
a data line driving circuit that
supplies, when one scanning line is selected by the selection of the scanning line from the first time, to the data lines corresponding to the pixels located in the one scanning line, a voltage corresponding to the gradations of the pixels, the voltage with one of a positive polarity which is a high potential with respect to a predetermined potential and a negative polarity which is a low potential with respect to the predetermined potential, as the data signal,
supplies, when one scanning line is selected by the selection of the scanning line from the second time, to the data lines corresponding to the pixels located in the one scanning line, a voltage corresponding to the gradations of the pixels, the voltage with the other of the positive polarity and the negative polarity, as the data signal, and
supplies, when one scanning line is selected by the selection of the scanning line from the third time, a predetermined voltage to the data lines corresponding to the pixels located in the one scanning line as the data signal.

2. The electrooptic device according to claim 1, wherein
the third time is later than the first time and earlier than the second time.

3. The electrooptic device according to claim 2, wherein
the scanning line driving circuit sequentially selects the plurality of scanning lines in a predetermined order from a fourth time which is later than the second time and earlier than the first time of the next one frame, and the data line driving circuit supplies, when one scanning line is selected by the selection of the scanning line from the fourth time, a predetermined voltage to the data lines corresponding to the pixels located in the one scanning line as the data signal, and
a period from the first time to the third time is different from a period from the second time to the fourth time.

4. The electrooptic device according to claim 2, wherein
the first time is later than a start time of the first field and is within a vertical blanking period with respect to the start time of the first field.

5. The electrooptic device according to claim 3, wherein
the first time is later than a start time of the first field and is within a vertical blanking period with respect to the start time of the first field.

6. The electrooptic device according to claim 1, wherein
the third time is later than the second time and earlier than the first time of the next one frame.

7. The electrooptic device according to claim 3, wherein
the second time is later than a start time of the second field and is within a vertical blanking period with respect to the start time of the second field.

8. The electrooptic device according to claim 6, wherein
the second time is later than a start time of the second field and is within a vertical blanking period with respect to the start time of the second field.

9. The electrooptic device according to claim 1, wherein
the electrooptic device is a normally black mode type, and
the predetermined voltage is a voltage that turns the gradations of the pixels into black.

10. A method for controlling an electrooptic device having pixels provided at intersections of a plurality of scanning lines and a plurality of data lines, the pixels each having gradation which turns into gradation in accordance with a voltage of a data signal which is supplied to the data lines when the scanning line is selected, the method comprising:
sequentially selecting the plurality of scanning lines in a predetermined order from a previously set first time of a first field in one frame, sequentially selecting the plurality of scanning lines in a predetermined order from a previously set second time of a second field in the one frame, and sequentially selecting the plurality of scanning lines in a predetermined order from a third time which is later than the first time and earlier than the second time or which is later than the second time and earlier than the first time of the next one frame,
supplying, when one scanning line is selected by the selection of the scanning line from the first time, to the data lines corresponding to the pixels located in the one scanning line, a voltage corresponding to the gradations of the pixels, the voltage with one of a positive polarity which is a high potential with respect to a predetermined potential and a negative polarity which is a low potential with respect to the predetermined potential, as the data signal,
supplying, when one scanning line is selected by the selection of the scanning line from the second time, to the data lines corresponding to the pixels located in the one scanning line, a voltage corresponding to the gradations of the pixels, the voltage with the other of the positive polarity and the negative polarity, as the data signal, and
supplying, when one scanning line is selected by the selection of the scanning line from the third time, a predetermined voltage to the data lines corresponding to the pixels located in the one scanning line as the data signal.

11. An electronic apparatus comprising the electrooptic device according to claim 1.

12. An electronic apparatus comprising the electrooptic device according to claim 2.

13. An electronic apparatus comprising the electrooptic device according to claim 3.

14. An electronic apparatus comprising the electrooptic device according to claim 4.

15. An electronic apparatus comprising the electrooptic device according to claim 5.

16. An electronic apparatus comprising the electrooptic device according to claim 6.

17. An electronic apparatus comprising the electrooptic device according to claim 7.

18. An electronic apparatus comprising the electrooptic device according to claim 8.

19. An electronic apparatus comprising the electrooptic device according to claim 9.
